(19) United States
(12) Patent Application Publication
(10) Pub. No.: US 2020/0411212 A1
(43) Pub. Date: Dec. 31, 2020

(54) Cable Assembly and Electronic Device Using Same

(71) Applicant: AAC Technologies Pte. Ltd., Singapore City (SG)

(72) Inventors: Yongli Chen, Shenzhen (CN); Jianan Wang, Shenzhen (CN); Xinying Xu, Shenzhen (CN)

(21) Appl. No.: 16/991,005

(22) Filed: Aug. 11, 2020

Related U.S. Application Data
(63) Continuation of application No. PCT/CN2019/092809, filed on Jun. 25, 2019.

(51) Int. Cl. H01B 5/14; H01B 11/10

(52) U.S. Cl. CPC H01B 5/14; H01B 19/00; H01B 11/1091

(57) ABSTRACT

The invention provides a cable assembly having a conductive element and a transmission cable. A strip-shaped opening slot is opened on the conductive element. The transmission cable is embedded in the opening slot. The transmission cable includes a substrate, a ground wire and a signal cable respectively provided on both sides of the substrate. The ground wire is exposed outside the opening of the opening slot. The signal cable is placed in the opening slot. The electronic device comprises the cable assembly described above. The cable assembly and electronic device of the present invention have the advantages of small size and good signal transmission performance. The cable assembly and electronic device of the present invention have the advantages of small size and good signal transmission performance.

### FIELD OF THE PRESENT DISCLOSURE

The invention relates to technical field of electricity connection, in particular to a cable assembly and an electronic device using the cable assembly.

### DESCRIPTION OF RELATED ART

The structure of the existing coaxial transmission cable and microstrip transmission is relatively simple. The existing coaxial transmission cable and microstrip transmission cable require a certain amount of space, which limits the internal layout of fast developed terminal products. Performance reduces when reducing the size of the transmission cable is focused.

Therefore, providing an improve cable assembly with a small size and good signal transmission performance has become a requirement of the field.

### SUMMARY OF THE INVENTION

One of the objects of the present invention is to provide a cable assembly with advantages of small size and good signal transmission performance.

Accordingly, the present invention provides a cable assembly, including: a conductive element; a transmission cable; and a strip-shaped opening slot opened on the conductive element for embedding the transmission cable. The transmission cable comprises a substrate disposed at and covering the opening slot, and a ground wire and a signal cable respectively provided on both sides of the substrate. The ground wire is exposed outside the opening slot. The ground wire and the conductive element are electrically and fixedly connected. The signal cable is placed in the opening slot, and a gap is formed between the signal cable and a bottom part of the opening slot.

In addition, the cable assembly further comprises a plurality of fixed areas arranged spaced from each other on two opposite sides of the transmission cable; wherein the ground wire and the fixed areas are arranged integrally and are electrically connected with the ground wire and the fixed areas; the fixed areas are arranged on and electrically connected with the surface of the conductive element where the opening slot is opened.

In addition, the fixed areas and the conductive element are electrically and fixedly connected by laser welding process.

In addition, each fixed area includes at least one laser perforation hole.

In addition, the fixed areas on both sides of the transmission cable are arranged symmetrically relative to the transmission cable.

In addition, the distance between two adjacent fixed areas is less than a quarter of the minimum wavelength of the signal transmitted by the signal cable, on the same side of the transmission cable.

In addition, on the same side of the transmission cable, a distance between two adjacent fixed areas is equal to a distance between another two adjacent fixed areas.

In addition, a permittivity of the substrate is 3.2˜3.4.

In addition, the material of the conductive element includes copper, aluminum or silver.

The present invention further provides an electronic device, comprising a cable assembly as described above, wherein the conductive element of the cable assembly is a metal frame of the electronic device.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a cable assembly provided by an embodiment of the present invention;

FIG. 2 is an exploded view of the cable assembly in FIG. 1;

FIG. 3 is an isometric view of a conductive element of the cable assembly;

FIG. 4 is an exploded view of a transmission cable of the cable assembly;

FIG. 5 is an isometric view of a fixed area of the cable assembly;

FIG. 6 is an isometric view of a cable assembly of another embodiment of the present invention;

FIG. 7 is an enlarged view of Part A in FIG. 6;

FIG. 8 is an isometric view of a cable assembly of another embodiment of the present invention;

FIG. 9 is an enlarged view of Part B in FIG. 8.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

The terms “first”, “second”, “third”, “fourth”, etc. (if any) in the description and claims of the present invention and the above drawings are used to distinguish similar objects; it is not necessary to describe a specific order or sequence. It should be understood that the data used in this way can be interchanged under appropriate circumstances so that the embodiments described herein can be implemented in an order which is not illustrated or described herein. In addition, the terms comprise” and “is provided” and any variations thereof are intended to cover non-exclusive inclusions. For example, processes, methods, systems, products or devices that include a series of steps or units are not necessarily limited to those steps or units clearly stated. Rather, it may include other steps or units not explicitly listed or inherent to these processes, methods, products or devices.

It should be noted that the descriptions related to “first”, “second”, etc. in the present invention are for descriptive purpose only, and cannot be understood as indicating or implying their relative importance or implicitly indicating the number of technical features indicated. Therefore, the features defined as “first” and “second” may include at least one of the features either explicitly or implicitly. In addition, the technical solutions in various embodiments can be combined with each other, but they must be based on the principle that they can be realized by the technicians who are skilled in the art. When the combination of technical solutions contradicts each other or cannot be realized, it should be considered that the combination of such technical solutions does not exist and is not within the protection scope claimed by the present invention.

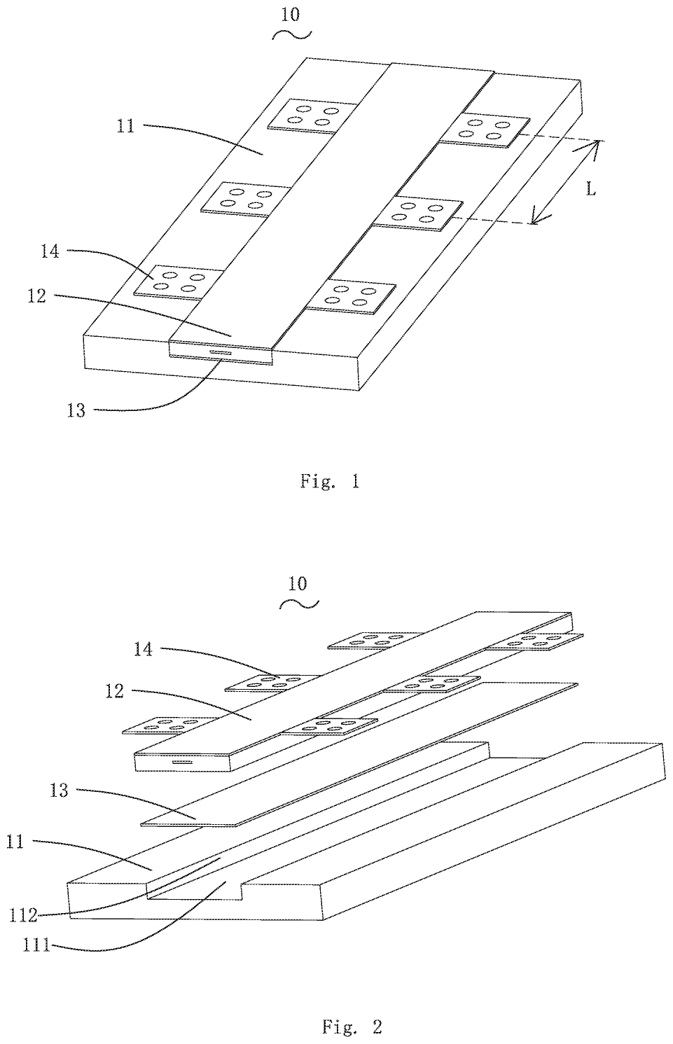

Please refer to both FIG. 1 and FIG. 2, the present invention provides a cable assembly 10 transmitting signals to other devices, for example the cable assembly 10 can be used on an antenna. The cable assembly 10 comprises a conductive element 11, a transmission cable 12, a conductive adhesive 13, and multiple fixed areas 14. On the conductive element 11, a strip-shaped opening slot 111 extending along the length direction of the conductive element 11 is opened. The transmission cable 12 is embedded in the opening slot 111, and the transmission cable 12 is fixedly connected to the opening slot 111 through the conductive adhesive 13. The transmission cable 12 is also fixedly connected and electrically connected with the conductive element 11 through the fixed areas 14.

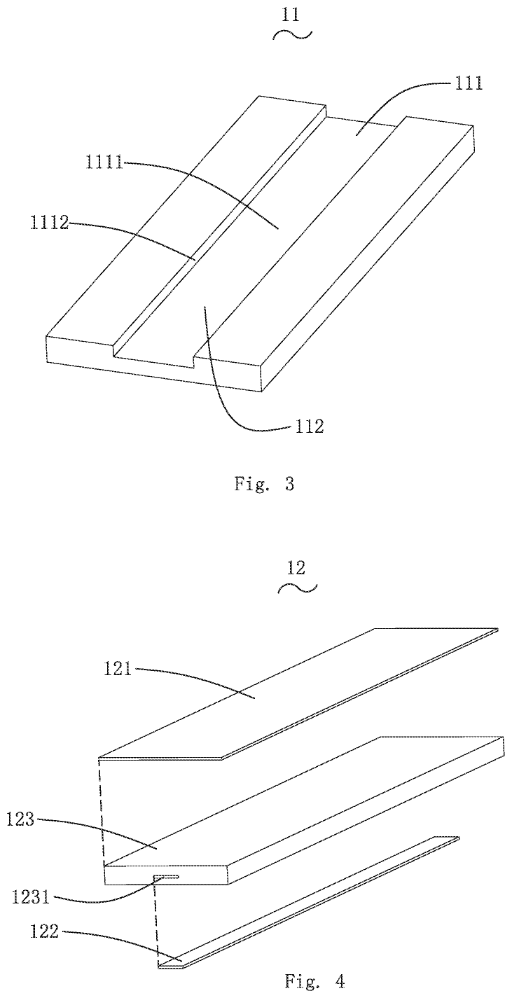

Please refer to FIG. 3, a length of the conductive element 11 can be preset as required. The material of the conductive element 11 includes a conductive material, specifically, the material of the conductive element 11 may include, but is not limited to, metal or alloy, such as copper, aluminum, or silver. It can be understood that the shape of the conductive element 11 can be changed as needed, if the cable assembly 10 needs to be bent, the conductive element 11 can also be bent as needed. The conductive element 11 may also adopt other shapes, such as a pentagonal prism shape, a hexagonal prism shape, etc.

The opening slot 111 is opened on a surface of the conductive element 11 extending along the length direction, and the opening slot 111 extends along the length direction of the conductive element 11. In this embodiment, a length of the opening slot 111 equals to a length of the conductive element 11, that is, the opening slot 111 extends all over the conductive element 11 along the length direction of the conductive element 11. The opening slot 111 includes a bottom part 1111 and two opposite side walls 1112 connected with the bottom part 1111.

The conductive adhesive 13 is both conductive and adhesive, and plays the role of electrical connection and fixed connection. The conductive adhesive 13 can electrically connect and fixedly connect the bottom part of the opening slot 111 of the conductive element 11 and the transmission cable 12. The conductive adhesive 13 may be conductive double-sided adhesive tape.

Please refer to FIG. 4, the transmission cable 12 is a microstrip cable. Specifically, the transmission cable 12 includes a ground wire 121, a signal cable 122, and a substrate 123. The substrate 123 is placed at and covers the opening of the opening slot 111. The ground wire 121 is set on one side of substrate 123 away from the bottom part of the opening slot 111. The ground wire 121 and the fixed areas 14 are electrically connected and fixedly connected. The signal cable 122 is placed in the opening slot 111. The ground wire 121 and substrate 123 are fixedly connected. The substrate 123 is fixedly connected with the bottom part 1111 of the opening slot 111 through the conductive adhesive 13. The signal cable 122 is placed in the substrate 123. Wherein, the ground wire 121, the substrate 123, and the conductive adhesive 13 are stacked layer by layer in an order.

The signal cable 122 is used to transmit signals. The signal cable 122 and the ground wire 121 are set with intervals. Such as it has a signal with a certain wavelength and frequency. The wavelength of the signal transmitted by the signal cable 122 may be a variable value, that is, the signal transmitted by the signal cable 122 is a signal within a frequency band, rather than a signal of fixed frequency.

The ground wire 121 is a conductive wire, and the ground wire 121 is used for grounding. The ground wire 121 is exposed outside the opening of the opening slot 111. The ground wire 121 shields the opening 112 of the opening slot 111, which can reduce the leakage of the signal transmitted in the signal cable 122. The material of the ground wire 121 is not limited, for example, the material of the ground wire 121 may include a conductive metal or alloy.

The substrate 123 is provided with a through hole 1231 passing through two opposite end surfaces of the substrate 123 along the length direction of the substrate 123. The through hole 1231 is used to accommodate the signal cable 122. The permittivity of the substrate 123 is 3.2˜3.4, and the permittivity of the substrate 123 is preferably 3.3. The material of the substrate 123 includes but is not limited to PI (Polyimide), PTFE (Poly tetra fluoroethylene), PEEK (Polyetherether ketone), and LCP (Liquid Crystal Polymer). Preferably, width of the substrate 123 and width of the opening slot 111 are equal. The substrate 123 is connected with the bottom part 1111 of the opening slot 111 through the conductive adhesive 13 which increases the stability of the transmission cable 12.

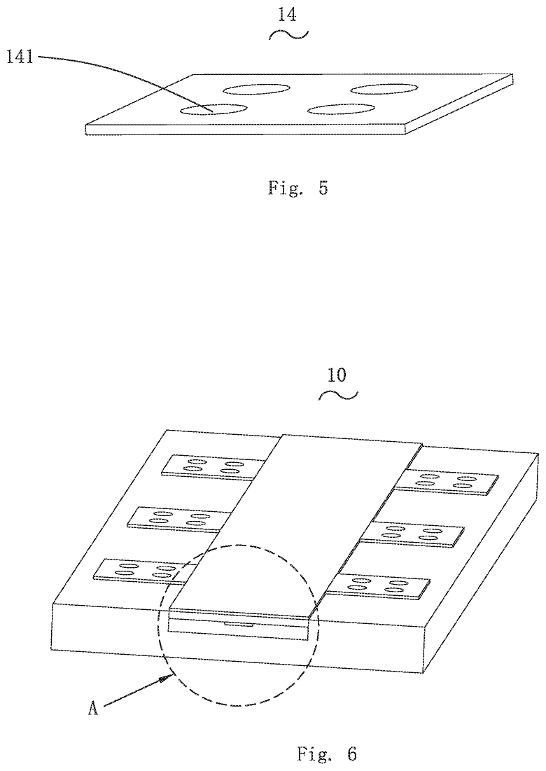

Please refer to both FIG. 5 and FIG. 1, multiple fixed areas 14 are arranged with intervals on each of the opposite sides of the ground wire 121. The fixed area 14 is also provided on the surface of the conductive element 11 where the opening slot 111 is opened and is fixedly and electrically connected to the surface. Preferably, the ground wire 121 and the fixed areas 14 are provided integrally and the ground wire 121 and the fixed areas 14 are electrically connected. The material of the fixed area 14 is not limited, for example, the material of the fixed area 14 may include a conductive metal or alloy, and for example, the fixed areas 14 may be a metal sheet. The fixed area 14 can be integrated with the ground wire 121. The fixed areas 14 on both sides of the ground wire 121 are arranged symmetrically relative the ground wire 121. Preferably, on the same side of the ground wire 121, the distance L between two adjacent fixed areas 14 is less than a quarter of the minimum wavelength of the signal transmitted by the signal cable 122.

Preferably, on the same side of the ground wire 121, the distance L between each two adjacent fixed areas 14 is equal. The fixed areas 14 and the conductive element 11 are electrically connected and fixedly connected by welding of laser process, and a laser perforation hole 141 is formed on the fixed areas 14 of the ground wire 121. The laser process is a laser technology, and continuous or pulsed laser beams can be used for welding of laser process. When welding by laser process, the power density of the laser is preferably greater than 107 W/cm². The metal surface recesses into “hole or hollow” under the heat effect, that is, the laser perforation hole 141 is formed to form deep melting welding, which has the characteristics of fast welding speed and large aspect ratio.

Welding of laser process is used to make the fixed areas 14 and the conductive element 11 tightly fixed, and the electrical connection effect is good. The fixed area 14 and the conductive element 11 are fully electrically connected. The ground wire 121 or the conductive element 11 is grounded, which can reduce signal leakage in signal cable 122. Each fixed area 14 includes at least a laser perforation hole 141. In this embodiment, each fixed area 14 includes four laser perforation holes 141, the four laser perforation holes 141 form squares and are located at the four corners of the square respectively. The laser perforation hole 141 reduces signal leakage.

The structure of the cable assembly 10 of this embodiment is simple, and the volume of the cable assembly 10 is small, which meets the demand for miniaturization.

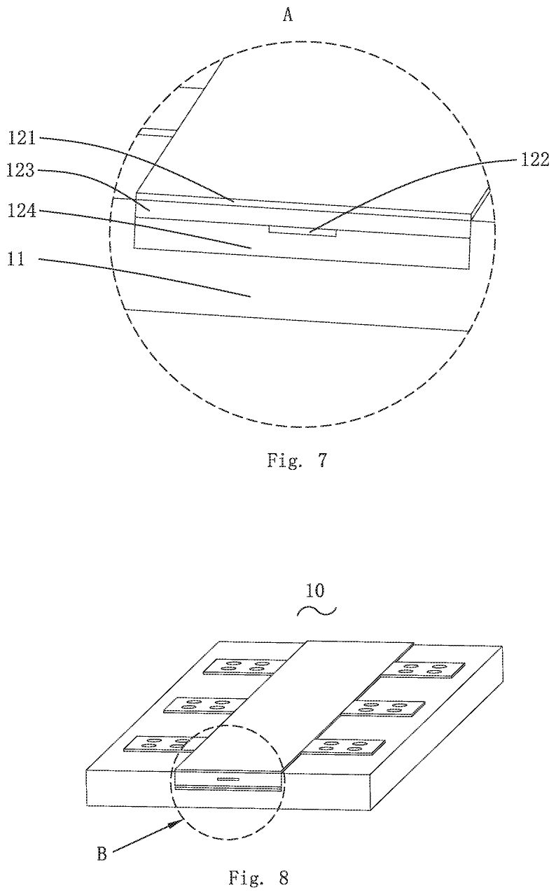

Please refer to both FIG. 6 and FIG. 7. In an embodiment, the setting the conductive adhesive 13 is omitted, and the signal cable 122 is no longer placed in the substrate 123. The signal cable 122 is placed on the side of the substrate 123 away from the ground wire 121 and connected with the substrate 123. A gap 124 is provided between the signal cable 122 and the bottom part 1111 of the opening slot 111.

Specifically, the cable assembly 10 includes a conductive element 11, a transmission cable 12 and multiple fixed areas. The conductive element 11 is provided with a strip-shaped opening slot 111 extending along the length direction of the conductive element 11. The transmission cable 12 is embedded in the opening slot 111. The transmission cable 12 is fixedly connected and electrically connected with the conductive element 11 through the fixed areas 14.

The transmission cable 12 is a microstrip cable. Specifically, the transmission cable 12 includes a ground wire 121, a signal cable 122, and a substrate 123. The substrate 123 covers and is arranged at the opening of opening slot 111. The ground wire 121 and the signal cable 122 are respectively arranged on both sides of the substrate 123. The ground wire 121 is arranged on the side of the substrate 123 away from the bottom part of the opening slot 111. The ground wire 121 and the fixed areas 14 are electrically connected and fixedly connected. The signal cable 122 is arranged in the opening slot 111, the ground wire 121 and the substrate 123 are fixedly connected. The signal cable 122 is provided on the side of the substrate 123 away from the ground wire 121 and connected with the substrate 123.

A gap 124 is arranged between the signal cable 122 and the bottom part 1111 of the opening slot 111, and air is the gap 124. Wherein, the ground wire 121, the substrate 123, and the signal cable 122 are stacked layer by layer in order. Because the permittivity of air is 1, the permittivity of the substrate 123 is 3.2˜3.4, the permittivity of air is less than the permittivity of the substrate 123. The gap 124 can reduce the overall permittivity of the cable assembly 10 which reduces the signal leakage and loss in the signal cable 122.

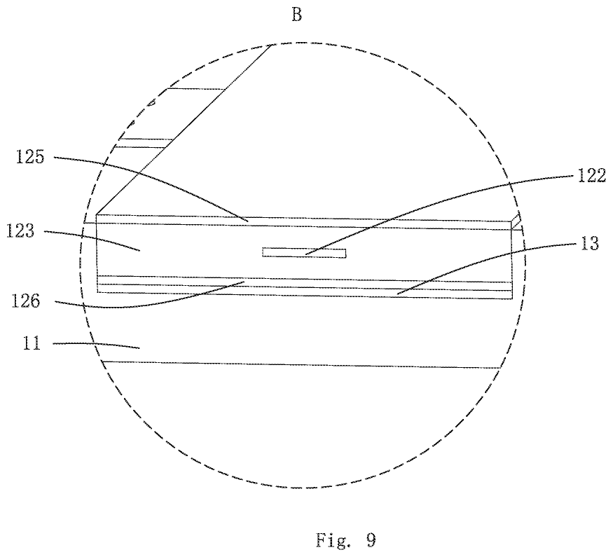

Please refer to both FIG. 8 and FIG. 9, in an embodiment, the transmission cable 12 further includes a second ground wire 126. For distinction, to be distinguished, the ground wire 121 of the aforementioned embodiment is called the first ground wire 125. The second ground wire 126 is placed in the opening slot 111, and the substrate 123 is connected with the second ground wire 126. The second ground wire 126 is connected with the bottom part 1111 of the opening slot 111 through the conductive adhesive 13. The conductive adhesive 13 conducts electricity, so that the electrical connection and the fixed connection of the second ground wire 126 and the conductive element 11 are realized.

Specifically, the cable assembly 10 includes a conductive element 11, a transmission cable 12, a conductive adhesive 13, and multiple fixed areas 14. A strip-shaped opening slot 111 extending along the length direction of the conductive element 11 is arranged on the conductive element 11. The transmission cable 12 is embedded in the opening slot 111, the transmission cable 12 is fixedly connected with the opening slot 111 through the conductive adhesive 13. The transmission cable 12 is also fixedly connected and electrically connected to the conductive element 11 through the fixed areas 14.

In this embodiment, the transmission cable 12 is a strip-shaped cable. Specifically, the transmission cable 12 includes a first ground wire 125, a signal cable 122, a substrate 123, and a second ground wire 126. The substrate 123 covers and is placed at the opening of the opening slot 111. The first ground wire 125 and the second ground wire 126 are arranged on both sides of the substrate 123 respectively. The first ground wire 125 is provided on the side of substrate 123 away from the bottom part of the opening slot 111. The first ground wire 125 and the fixed areas 14 are electrically connected and fixedly connected. The signal cable 122 and the second ground wire 126 are placed in the opening slot 111. The first ground wire 125 and the substrate 123 are fixedly connected. The substrate 123 is connected with the second ground wire 126. The second ground wire 126 is connected with the bottom part 1111 of the opening slot 111 through the conductive adhesive 13. The signal cable 122 is placed in the substrate 123. Wherein, the first ground wire 125, the substrate 123, the second ground wire 126 and the conductive adhesive 13 are stacked layer by layer in order.

The second ground wire 126 is a conductive wire, and the second ground wire 126 is used for grounding. The material of the second ground wire 126 is not limited, for example, the material of the second ground wire 126 may include a conductive metal or alloy. Preferably, the width of the second ground wire 126 is equal to the width of the opening slot 111. Wherein, the ground wire 121 of the first ground wire 125, the substrate 123, the second ground wire 126, and the conductive adhesive 13 are stacked layer by layer in order.

The present invention also provides an electronic device. The electronic device may be a mobile terminal, such as a mobile phone. The electronic device includes the cable assembly 10 described above, and the conductive element 11 of the cable assembly 10 is a metal frame of the electronic device, for example, the conductive element 11 of the cable assembly 10 is a metal middle frame or a metal outer frame of the electronic device. Installing the transmission cable 12 on the metal frame of the electronic device is a new assembly method that saves space and reduces the volume of the electronic device.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A cable assembly, including:
a conductive element;
a transmission cable;
a strip-shaped opening slot opened on the conductive element for embedding the transmission cable; wherein
the transmission cable comprises a substrate disposed at and covering the opening slot, and a ground wire and a signal cable respectively provided on both sides of the substrate;
the ground wire is exposed outside the opening slot;
the ground wire and the conductive element are electrically and fixedly connected;
the signal cable is placed in the opening slot, and a gap is formed between the signal cable and a bottom part of the opening slot.

2. The cable assembly as described in claim 1, further comprising a plurality of fixed areas arranged spaced from each other on two opposite sides of the transmission cable; wherein the ground wire and the fixed areas are arranged integrally and are electrically connected with the ground wire and the fixed areas; the fixed areas are arranged on and electrically connected with the surface of the conductive element where the opening slot is opened.

3. The cable assembly as described in claim 2, wherein the fixed areas and the conductive element are electrically and fixedly connected by laser welding process.

4. The cable assembly as described in claim 2, wherein each fixed area includes at least one laser perforation hole.

5. The cable assembly as described in claim 2, wherein the fixed areas on both sides of the transmission cable are arranged symmetrically relative to the transmission cable.

6. The cable assembly as described claim 2, wherein the distance between two adjacent fixed areas is less than a quarter of the minimum wavelength of the signal transmitted by the signal cable, on the same side of the transmission cable.

7. The cable assembly as described in claim 2, wherein on the same side of the transmission cable, a distance between two adjacent fixed areas is equal to a distance between another two adjacent fixed areas.

8. The cable assembly as described in claim 1, wherein a permittivity of the substrate is 3.2˜3.4.

9. The cable assembly as described in claim 1, wherein the material of the conductive element includes copper, aluminum or silver.

10. An electronic device, comprising a cable assembly as described in claim 1, wherein the conductive element of the cable assembly is a metal frame of the electronic device.

11. An electronic device, comprising a cable assembly as described in claim 2, wherein the conductive element of the cable assembly is a metal frame of the electronic device.

12. An electronic device, comprising a cable assembly as described in claim 3, wherein the conductive element of the cable assembly is a metal frame of the electronic device.

13. An electronic device, comprising a cable assembly as described in claim 4, wherein the conductive element of the cable assembly is a metal frame of the electronic device.

14. An electronic device, comprising a cable assembly as described in claim 5, wherein the conductive element of the cable assembly is a metal frame of the electronic device.

15. An electronic device, comprising a cable assembly as described in claim 6, wherein the conductive element of the cable assembly is a metal frame of the electronic device.

16. An electronic device, comprising a cable assembly as described in claim 7, wherein the conductive element of the cable assembly is a metal frame of the electronic device.

17. An electronic device, comprising a cable assembly as described in claim 8, wherein the conductive element of the cable assembly is a metal frame of the electronic device.

18. An electronic device, comprising a cable assembly as described in claim 9, wherein the conductive element of the cable assembly is a metal frame of the electronic device.
